(19) United States
(12) Patent Application Publication
(10) Pub. No.: US 2008/0112650 A1
(43) Pub. Date: May 15, 2008

(54) Image Processor, Image Processing Method, and Program

(76) Inventors: Hiroaki ITOU, Kanagawa (JP); Naoyuki MIYADA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/872,540

(22) Filed: Oct. 15, 2007

(30) Foreign Application Priority Data
Nov. 10, 2006 (JP) P2006-305752

(51) Int. Cl. G06K 9/54

(52) U.S. Cl. 382/304

(57) ABSTRACT

An image processor is disclosed. The image processor includes: N execution means (where N is 2 or greater) for executing given image processing; and a control means for dividing an input image into N parts from a boundary portion between given processing unit blocks to be processed by the N execution means and controlling the execution of the image processing on the resulting N parts of the image performed by the N execution means. The control means extracts an assigned image from the input image for each one of the N parts of the image and assigns the N extracted assigned images to the N execution means, respectively. The N execution means execute the image processing on the images assigned by the control means in a parallel manner.

### CROSS REFERENCES TO RELATED APPLICATIONS

The present invention contains subject matter related to Japanese Patent Application JP2006-305752, filed in the Japanese Patent Office on Nov. 10, 2006, the entire contents of which being incorporated herein by reference.

### BACKGROUND OF THE INVENTION

1. Field of the Invention

The present invention relates to image processor, image processing method, and program and, more particularly, to image processor, image processing method, and program which, when an image is divided into parts and given image processing is performed, for example, permit the image processing to be carried out efficiently.

2. Description of the Related Art

Many kinds of processing such as block distortion reduction (JP-A-10-191335 (patent reference 1)) are available as methods of processing images. Where an image of interest (hereinafter may be referred to as the processed image) is processed by a single processor, if the size of the processed image is large, a long time may be taken to perform the processing.

Accordingly, an attempt has been made to solve this problem. That is, the image to be processed is divided into parts according to the features of the image or executed image processing, and the parts of the image are assigned to plural processors such that the processors perform the image processing in a parallel manner.

### SUMMARY OF THE INVENTION

However, where the boundary between first and second parts of an image is image-processed and it may be necessary to utilize portions of the second part of the image, the processing on the boundary is carried out, for example, by making use of the results of processing on the second part of the image.

Accordingly, in this case, it may be necessary to wait for completion of the processing on the second part of the image. Therefore, it may be necessary to take account of the order in which the parts of the image are processed. This complicates the control over the processors. In addition, it may be impossible to process the parts of the image in a parallel manner. Hence, the processing may not be performed quickly.

For example, according to Amdahl's law, the improvement of speed made by n processors is defined to be 1/(s+((1−s)/n)), where s (0<s<1) is the ratio between the portion of the whole program that can be executed in a parallel manner and the portion that cannot be executed in a parallel manner. Therefore, according to Amdahl's law, in a case where the ratio of the portion that can be parallelized is set to 0.5 (i.e., s=0.5), the performance will not be doubled even if 100 processors are used. It is generally difficult to set the parallelized portion to 0.5 or more by task allocation. It can be said that it is difficult to enjoy the merits of parallelization.

When the boundary between first and second parts of an image is image-processed, even when it is necessary to utilize portions of the second part of the image, it is possible not to use the results of processing on the second part of the image. In this case, the boundary may need to be processed specially, e.g., a given portion of a part of the image is referenced. Therefore, it is necessary to vary the conditions under which the boundary is image-processed from the conditions under which other parts of the image are image-processed. This complicates the computation for image processing.

In this way, in the past, in a case where an image is divided into parts and given image processing is performed, it may be sometimes impossible to efficiently carry out the image processing.

Thus, where an image is divided into parts and given image processing is performed, it is desirable to be able to efficiently perform the image processing.

An image processor according to one embodiment of the present invention has: N execution means (where N is 2 or greater) for executing given image processing and a control means. The control means divides an input image into N parts from a boundary portion between given processing unit blocks and controls the execution of the image processing on the resulting N parts of the image performed by the N execution means. The control means extracts an assigned image from the input image for each one of the N parts of the image. The assigned image includes a first part of the image and a marginal image. The marginal image is a portion of a second part of the image that is adjacent to the first part of the image. The marginal image is necessary in performing the image processing on a given portion of the first part of the image. The N extracted assigned images are assigned to the N execution means, respectively. The N execution means execute the image processing on the images assigned by the control means in a parallel manner.

The execution means can execute processing for block distortion reduction or processing for frame distortion reduction.

The execution means execute plural sets of image processing. The control means can extract an image including a marginal image as an assigned image, the marginal image having a greater extent out of marginal images processed in each set of image processing.

The execution means can execute both processing for block distortion reduction and processing for frame distortion reduction.

An image processing method according to one embodiment of the present invention includes the steps of: executing given image processing by means of N execution steps (where N is 2 or greater); and dividing an input image into N parts from a boundary portion between given processing unit blocks and controlling the execution of the image processing on the resulting N parts of the image in the N execution steps. In this image processing method, the controlling step extracts an assigned image from the input image for each one of the N parts of the image and assigns the N extracted assigned images to the N execution steps, respectively. Each assigned image includes a first part of the image and a marginal image. The marginal image is a portion of a second part of the image adjacent to the first part of the image. The marginal image is necessary in performing the image processing on a given portion of the first part of the image. The N execution steps execute the image processing on the images assigned by the controlling step in a parallel manner.

A program according to one embodiment of the present invention causes a computer to perform image processing including the steps of: executing given image processing by means of N execution steps (where N is two or greater); and dividing an input image into N parts from a boundary portion between given processing unit blocks and controlling the execution of the image processing on the resulting N parts of the image in the N execution steps. In the image processing, the controlling step extracts an assigned image from the input image for each one of the N parts of the image and assigns the N extracted assigned images to the N execution steps, respectively. Each assigned image includes a first part of the image and a marginal image. The marginal image is a portion of a second part of the image adjacent to the first part of the image. The marginal image is necessary in performing the image processing on a given portion of the first part of the image. The N execution steps execute the image processing on the images assigned by the controlling step in a parallel manner.

In an image processor, image processing method, or program according to an embodiment of the present invention, an input image is divided into N parts from a boundary portion between given processing unit blocks. Execution of image processing on the resulting N parts of the image is controlled. At this time, an assigned image including a first part of the image and a marginal image is extracted from the input image. The marginal image is a portion of a second part of the image adjacent to the first part of the image, and is necessary in performing the image processing on a given portion of the first part of the image. The extracted assigned images are assigned to sets of image processing, respectively. The sets of the image processing on the assigned images are executed in a parallel manner.

According to embodiments of the present invention, in a case where an image is divided and given image processing is performed, for example, the image processing can be carried out efficiently.

For example, where an image is divided and given image processing is performed, the image processing can be carried out at high speed under simple control because any special processing that would normally be performed on boundaries of division is not added and because it is not necessary to control the order of executed steps when the steps are carried out in a parallel manner by plural coprocessors. Furthermore, the input image can be image-processed at higher speed than where processing is performed by a single processor without dividing the image.

### BRIEF DESCRIPTION OF THE DRAWINGS

FIG. 1 is a block diagram showing an example of structure of a related-art image processor.

FIG. 2 is a diagram illustrating processing for block noise reduction (BNR).

FIG. 3 is another diagram illustrating the processing for BNR.

FIG. 4 is a further diagram illustrating the processing for BNR.

FIG. 5 is a block diagram illustrating the operations of various parts of an image processor in a case where the processing for BNR is performed.

FIG. 6 is a diagram illustrating processing for FNR.

FIG. 7 is another diagram illustrating the processing for FNR.

FIG. 8 is a further diagram illustrating the processing for FNR.

FIG. 9 is a diagram illustrating the operations of the various parts of an image processor in a case where processing for FNR is performed.

FIG. 10 is a diagram illustrating the operations of the various parts of an image processor in a case where processing for BNR and processing for FNR are performed.

FIG. 11 is a flowchart illustrating the operations of the various portions of an image processor in a case where processing for BNR and processing for FNR are performed.

FIG. 12 is a diagram showing a storage region in a local memory.

FIG. 13 is a block diagram showing an example of structure of a computer.

### DESCRIPTION OF THE PREFERRED EMBODIMENTS

Embodiments of the present invention are hereinafter described. The relationships between the constituent components of the present invention and the embodiments described in the specification or shown in the drawings are as follows. The description is intended to confirm that embodiments supporting the present invention are described in the specification or drawings. Accordingly, if there is any embodiment that is not described herein as an embodiment which is described in the specification or drawings and corresponds to constituent components of the present invention, it does not mean that the embodiment fails to correspond to the constituent components. Conversely, if there is any embodiment described herein as one corresponding to the constituent components, it does not mean that the embodiment fails to correspond to constituent components other than those constituent components.

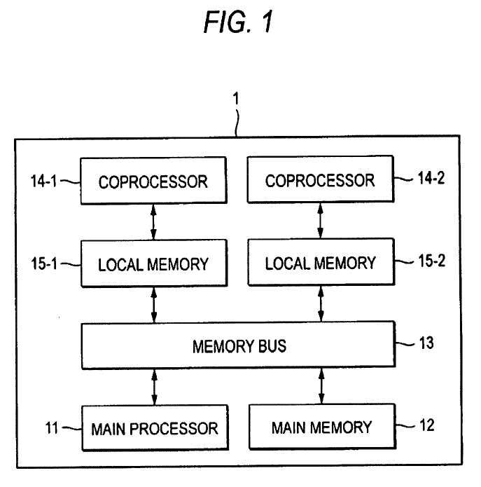

An image processor according to one embodiment of the present invention has N execution means (where N is two or greater) (e.g., coprocessors 14-1 and 14-2 of FIG. 1) for executing given image processing and a control means (e.g., main processor 11 of FIG. 1) for dividing an input image into N parts from a boundary portion between given processing unit blocks and controlling the execution of the image processing on the resulting N parts of the image performed by the N execution means. In this image processor, the control means extracts an assigned image from the input image for each one of the N parts of the image. The assigned image includes a first part of the image and a marginal image. The marginal image is a portion of a second part of the image that is adjacent to the first part of the image, and is necessary in performing the image processing on a given portion of the first part of the image. The control means assigns the N extracted assigned images to the N execution means, respectively. The N execution means execute the image processing on the images assigned by the control means in a parallel manner.

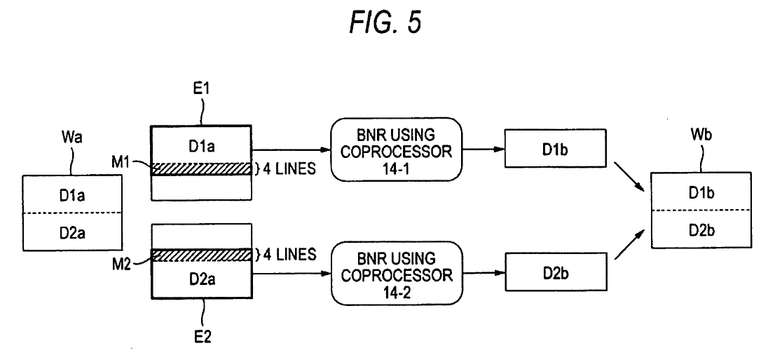

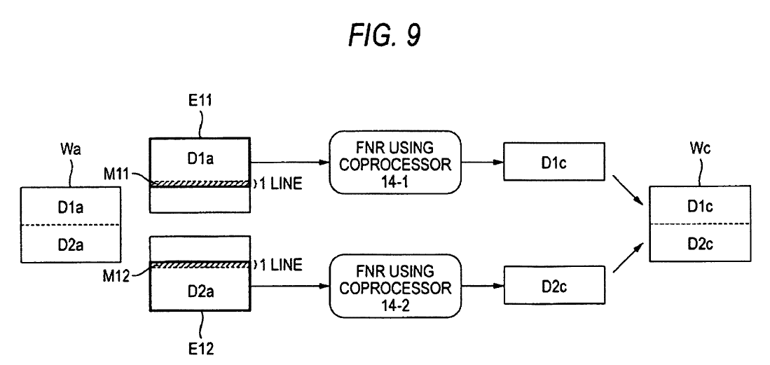

The execution means can execute processing for block distortion reduction (for example, the processing of FIG. 5) or processing for frame distortion reduction (for example, the processing of FIG. 9).

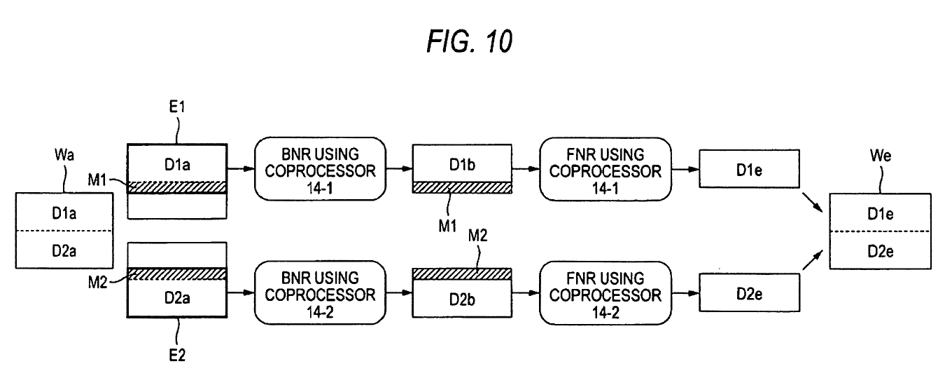

The execution means execute plural sets of image processing (e.g., processing for BNR and processing for FNR). The control means can extract an image including the marginal image having a greater extent as the assigned image out of the marginal images in each set of image processing (for example, as illustrated in FIG. 10).

The execution means can execute both processing for block distortion reduction and processing for frame distortion reduction (for example, as illustrated in FIG. 10).

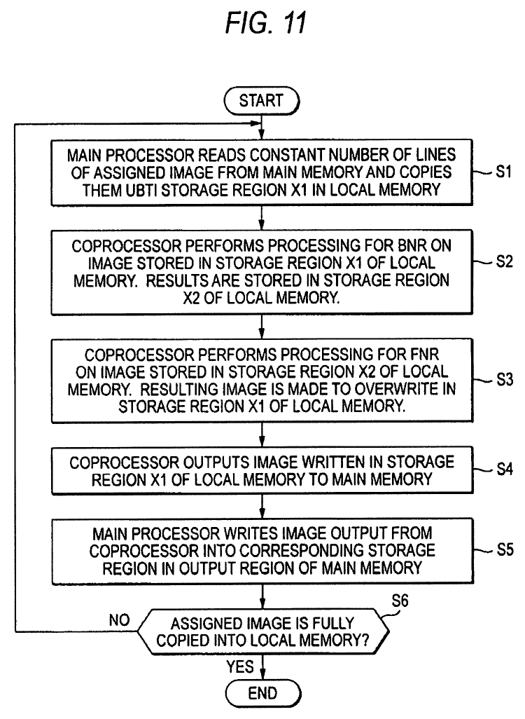

An image processing method or program according to an embodiment of the present invention includes the steps of: executing given image processing by means of N execution steps (where N is two or greater) (e.g., step S2 or S3 of FIG. 11); and dividing an input image into N parts from a boundary portion between given processing unit blocks and controlling the execution of the image processing on the resulting N parts of the image in the N execution steps (for example, step S1 of FIG. 11). In this image processing method or program, the controlling step extracts an assigned image from the input image for each one of the N parts of the image. The assigned image includes a first part of the image and a marginal image that is a portion of a second part of the image adjacent to the first part of the image. The marginal image is necessary in performing the image processing on a given portion of the first part of the image. The N extracted assigned images are assigned to the N execution steps, respectively. The N execution steps execute the image processing on the images assigned by the controlling step in a parallel manner.

FIG. 1 shows an example of structure of an image processor 1 to which the embodiment of the present invention is applied.

An image is entered into the image processor 1 and stored in a main memory 12. A main processor 11 extracts a given region as an assigned image from the image stored in the main memory 12, and supplies the extracted image to coprocessors 14-1 and 14-2 via a memory bus 13.

The main processor 11 stores each assigned image, which has been image-processed in a given manner and is supplied from the coprocessor 14-1 or 14-2, into a storage region within the main memory 12 and in the position corresponding to the position of the assigned image on the input image. If necessary, the main processor 11 outputs the image stored in the storage region to a display portion (not shown) and displays the image.

The two coprocessors 14-1 and 14-2 (hereinafter referred to simply as the coprocessors 14 in a case where it is not necessary discriminate between the individual coprocessors) image-process the assigned images of the input image supplied from the main processor 11 in a given manner as the need arises by utilizing local memories 15-1 and 15-2, and supply the obtained images to the main processor 11.

In the embodiment of FIG. 1, there are two coprocessors 14. It is also possible to provide more coprocessors.

The operations of various portions performed when the image processor 1 executes processing for block noise reduction (BNR) are next described.

It is known that where an image is compressed or uncompressed by block encoding such as DCT (discrete cosine transform) coding, block distortion (i.e., block noise) is produced.

This processing for block distortion reduction is carried out by correcting the values of pixels at the boundary portions between DCT blocks by corrective values calculated from a given parameter obtained from the values of given pixels at the boundary portions between the DCT blocks.

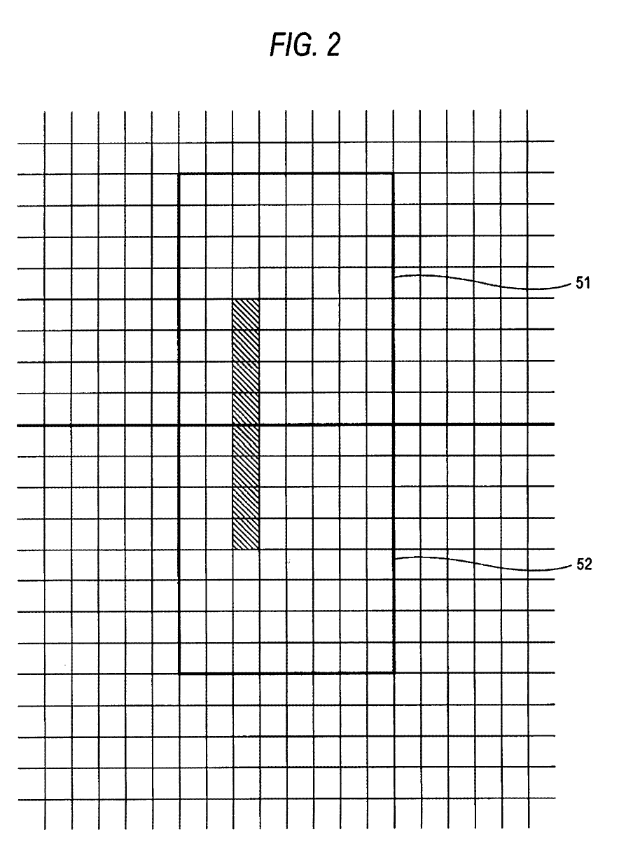

For example, as shown in FIG. 2, DCT blocks 51 and 52 are adjacent to each other vertically. Four pixels (shaded in the figure) on the upper side of the boundary between the adjacent blocks 51 and 52 and four pixels (similarly shaded in the figure) on the lower side of the boundary are regarded to be in a range of correction. The values of the pixels in the range of correction are corrected using corrective values which are computed by the use of a given parameter derived from these two sets of pixels.

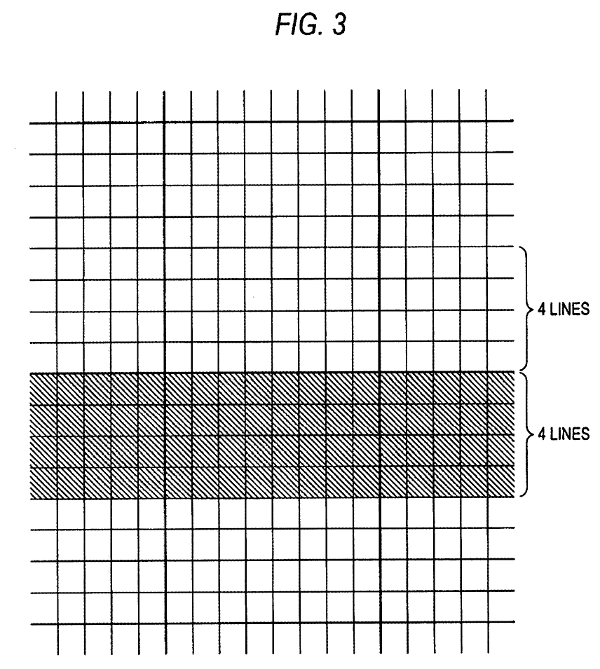

That is, with respect to the DCT blocks (range surrounded by the bold line in the figure) shown in FIG. 3, in a case where processing for BNR is performed about four lines from the boundary portion of the upper blocks out of the DCT blocks adjacent to each other vertically, the values of the pixels on the 4 (shaded) lines from the boundary portion of the lower DCT blocks would be necessary.

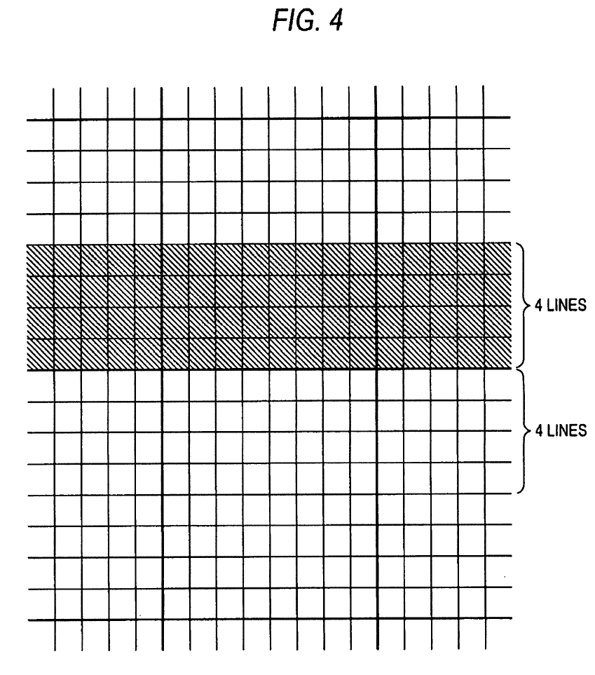

Furthermore, as shown in FIG. 4, in a case where processing for BNR is performed about 4 lines from the boundary portion of the lower DCT blocks out of the DCT blocks adjacent to each other vertically, the values of pixels on the 4 lines (shaded in the figure) from the boundary portion of the upper DCT blocks may be required.

Accordingly, where the processing for BNR is performed, the main processor 11 extracts an assigned image E1 from the input image Wa when the input image Wa is divided into two vertically adjacent images, i.e., parts of image D1a and D2a, from the boundary portion between the DCT blocks, for example, as shown in FIG. 5. The assigned image E1 is made of the upper part of the image D1a and 4 lines (i.e., the shaded portion of the 4 lines located on the upper side of the part of the image D2a) (hereinafter referred to as the marginal image M1) located on the lower side of the boundary necessary for processing for BNR on the DCT blocks located at the boundary between the parts of the image D1a and D2a.

Furthermore, the main processor 11 extracts an assigned image E2 from the input image Wa. The assigned image E2 is made of a lower part of the image D2a and 4 lines located on the upper side of the boundary between the parts of the image D2a and D1a, the 4 lines (i.e., shaded 4 lines on the lower side of the part of the image D1a) being necessary for processing for BNR on the DCT blocks at the boundary between the parts of the image D2a and D1a. The shaded image is hereinafter referred to as the marginal image M2.

The main processor 11 supplies the assigned images E1 and E2 extracted from the input image Wa, for example, to the coprocessors 14-1 and 14-2, respectively.

As shown in FIG. 5, the coprocessor 14-1 performs processing for BNR on the assigned image E1 supplied from the main processor 11, the processing for BNR being described by referring to FIGS. 2 and 3. The resulting image is supplied to the main processor 11.

The results of the processing for BNR on the marginal image M1 of the assigned image E1 supplied from the main processor 11 are obtained from the results of the processing on the assigned image E2. Therefore, the coprocessor 14-1 performs processing for BNR on the assigned image E1. The part of the image D1a which is obtained as a result of the processing excluding the marginal image M1 is supplied to the main processor 11. The part of the image D1a that has undergone the processing for BNR is hereinafter referred to as the part of the image D1b.

As shown in FIG. 5, the coprocessor 14-2 performs processing for BNR on the assigned image E2 supplied from the main processor 11, the processing for BNR being described by referring to FIGS. 2 and 4.

The results of the processing for BNR on the marginal image M2 of the assigned image E2 supplied from the main processor 11 are obtained from the results of processing on the assigned image E1. Therefore, the coprocessor 14-2 performs processing for BNR on the assigned image E2 and supplies the obtained image excluding the marginal image M2 (i.e., the part of the image D2a) to the main processor 11. The part of the image D2a undergone the processing for BNR is hereinafter referred to as the part of the image D2b.

The main processor 11 stores the part of the image D1b supplied from the coprocessor 14-1 into an output storage region in the main memory 12, the output storage region being in a position corresponding to the position of the part of the image D1a on the input image Wa. The main processor stores the part of the image D2b supplied from the coprocessor 14-2 into an output storage region in the main memory 12, the output storage region being in a position corresponding to the position of the part of the image D2a on the input image Wa.

Since the parts of the image D1b and D2b supplied from the coprocessors 14-1 and 14-2 are images corresponding to the parts of the image D1a and D2a, respectively, of the input image Wa, the parts of the image D1b and D2b are stored in storage regions in positions corresponding to the positions of the parts of the image D1a and D2a on the input image Wa. Consequently, as shown in FIG. 5, an input image Wa undergone processing for BNR can be obtained. The input image Wa processed in this way is hereinafter referred to as the input image Wb.

As described so far, where an input image is divided from a boundary portion between the DCT blocks and the resulting parts of the image are processed for BNR, the assigned image E1 is extracted from the input image Wa. The assigned image E1 includes, for example, the part of the image D1a and the marginal image M1 that is a portion of the part of the image D2a adjacent to the part of the image D1a, the marginal image M1 being necessary in performing processing for BNR on the boundary portion between the parts of the image D1a and D2a, as shown in FIG. 5. The extracted assigned image E1 is assigned to the coprocessor 14-1. Consequently, the coprocessor 14-1 can carry out processing for BNR on the part of the image D1a, for example, without the need to wait for completion of the processing performed by the other coprocessor 14-2 or without the need to specially process the boundary portion between the parts of the image D1a and D2a.

That is, it is not necessary to take account of the order in which the operations are performed by the coprocessors 14. This facilitates controlling the coprocessors 14. Processing under given conditions can be performed repeatedly. Hence, the processing for BNR can be effected at high speed. Of course, the input image can be processed at higher speed than the case where the input image is not divided and processing is performed by a single processor.

The operations of various portions when the image processor 1 performs processing for FNR (frame noise reduction) are next described.

A kind of FNR (frame noise reduction) processing has been proposed as a method of removing noise from a video signal (see, for example, JP-A-55-42472 and “Journal of the Television Society of Japan”, Vol. 37, No. 12 (1983), pp. 56-62). In particular, noise is efficiently removed by making use of the statistical property of the video signal and the visual characteristics of the eye simultaneously with frame correlation.

This processing is carried out by detecting noises showing no frame correlation within the video signal as frame difference signals and subtracting those of the frame difference signals having no two-dimensional correlation as noises from the input video signal.

In order to detect components having no two-dimensional correlation from the frame difference signal, the frame difference signal is orthogonally transformed. One available method of implementing this is a combination of a Hadamard transform and a nonlinear circuit. The Hadamard transform is performed by referring to 4×2 pixels at a time.

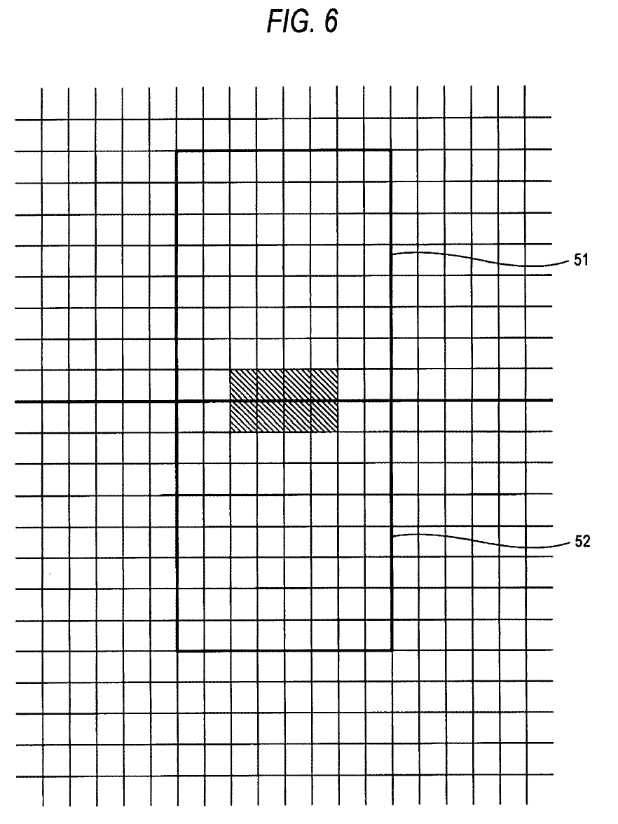

Accordingly, as shown in FIG. 6, four pixels (shaded in the figure) of the DCT blocks 51 which are adjacent to each other vertically and to the DC blocks 52 and four pixels (similarly shaded in the figure) of the DCT blocks 52 which are adjacent to the DCT blocks 51 may be referenced.

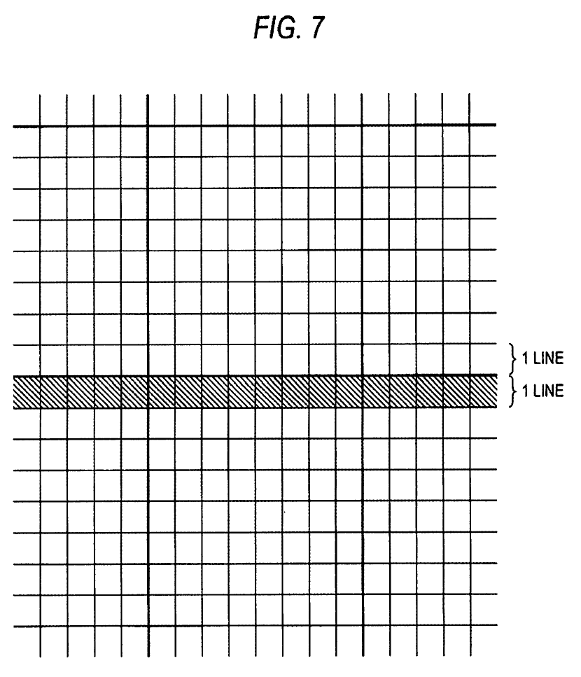

That is, as shown in FIG. 7, with respect to the upper DCT blocks which are adjacent to each other vertically, the pixels on 1 line (shaded in the figure) of upper DCT blocks which is adjacent to the lower DCT blocks and the pixels on 1 line (similarly shaded in the figure) of lower DCT blocks which is adjacent to the upper DCT blocks are referenced.

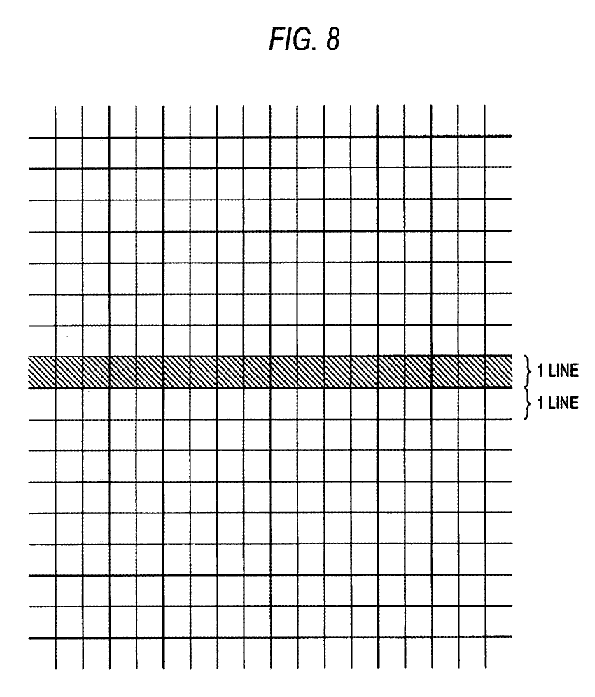

As shown in FIG. 8, with respect to the lower DCT blocks, the values of the pixels on 1 line (shaded in the figure) of the lower DCT blocks which is adjacent to the upper DCT blocks and the values of the pixels on 1 line (similarly shaded in the figure) of the upper DCT blocks which is adjacent to the lower DCT blocks are referenced.

Accordingly, where processing for FNR is performed, when the main processor 11 divides the input image Wa into two parts of the image D1a and D2a arranged in the vertical direction from the boundary portion between DCT blocks, for example, as shown in FIG. 9, the main processor extracts an assigned image E11 from the input image Wa. The assigned image E11 includes the upper part of the image D1a and 1 line on the lower side of the boundary between the parts of the image D1a and D2a, the 1 line being necessary in performing processing for FNR on the DCT blocks at the boundary between the parts of the image D1a and D2a. The 1 line is the shaded image portion of 1 line on the upper side of the part of the image D2a, and is hereinafter referred to as the marginal image M11.

Furthermore, the main processor 11 extracts an assigned image E12 from the input image Wa. The assigned image E12 includes a lower part of the image D2a and 1 line located on the upper side of the boundary between the lower and upper parts of the image D2a and D1a. The 1 line is necessary in performing processing for FNR on the DCT blocks located at the boundary between the parts of the image D2a and D1a. The 1 line is an image of the shaded portion of 1 line located on the lower side of the part of the image D1a, and is hereinafter referred to as the marginal image M12.

The main processor 11 supplies the assigned image E11 extracted from the input image Wa, for example, to the coprocessor 14-1 and supplies the assigned image E12 to the coprocessor 14-2.

The coprocessor 14-1 performs processing for FNR on the assigned image E11 supplied from the main processor 11 as illustrated in FIG. 9, the processing being described by referring to FIGS. 6 and 7.

The marginal image M11 of the assigned image E11 of the input image Wa supplied from the main processor 11 is processed for FNR. The results are obtained as the results of processing on the assigned image E12. Accordingly, the coprocessor 14-1 performs processing for FNR on the assigned image E11, and supplies the part of the image D1a of the obtained image excluding the marginal image M11 to the main processor 11. The part of the image D1a processed for FNR is hereinafter referred to as the part of the image D1c.

As shown in FIG. 9, the coprocessor 14-2 performs processing for FNR on the assigned image E12 supplied from the main processor 11, the processing being described by referring to FIGS. 6 and 8.

The marginal image M12 of the assigned image E12 of the input image Wa supplied from the main processor 11 is processed for FNR. The results are obtained as the results of the processing on the assigned image E11. Therefore, the coprocessor 14-2 performs processing for FNR on the assigned image E12, and supplies the part of the image D2a of the obtained image excluding the marginal image M12 to the main processor 11. The part of the image D2a processed for FNR is hereinafter referred to as the part of the image D2c.

The main processor 11 stores the part of the image D1c supplied from the coprocessor 14-1 into an output storage region of the main memory 12 which is in a position corresponding to the position of the part of the image D1a on the input image Wa, and stores the part of the image D2c supplied from the coprocessor 14-2 into an output storage region of the main memory 12 which is in a position corresponding to the position of the part of the image D2a on the input image Wa.

Because the parts of the image D1c and D2c supplied from the coprocessors 14-1 and 14-2, respectively, correspond to the parts of the image D1a and D2a, respectively, the input image Wa processed for FNR can be obtained by storing the parts of the image D1c and D2c into the output storage regions in positions corresponding to the positions of the parts of the image D1a and D2a on the input image Wa. The input image Wa already processed for FNR is hereinafter referred to as the input image Wc.

In this way, where an input image is divided from a boundary portion between the DCT blocks and the resulting parts of the image are processed for FNR, the assigned image E11 including the part of the image D1a and the marginal image M11 is extracted, for example, from the input image Wa and assigned to the coprocessor 14-1 as shown in FIG. 9. The marginal image M11 is a portion of the part of the image D2a adjacent to the part of the image D1a and necessary for processing for FNR on the boundary between the parts of the image D1a and D2a. Therefore, the coprocessor 14-1 can execute the processing for FNR on the part of the image D1a, for example, without the need to wait for completion of the processing performed by the other coprocessor 14-2 or without the need to specially process the boundary portion between the parts of the image D1a and D2a.

That is, it is not necessary to take account of the order in which the operations are performed by the coprocessors 14. Therefore, the coprocessors 14 are controlled easily. Furthermore, it is possible to repetitively carry out processing placed under certain conditions and so the processing for FNR can be performed at high speed. Of course, the input image can be processed at higher speed than in the case where the input image is not divided and the processing is performed by a single processor.

In the process described so far, processing for BNR and processing for FNR are performed separately. Instead, both kinds of processing may be performed.

In this case, each of the marginal images M1 and M2 (FIG. 5) for processing for BNR is made of 4 lines. Each of the marginal images M11 and M12 for processing for FNR is made of 1 line (FIG. 9). Therefore, where operations for these kinds of processing are performed sequentially in the coprocessors 14, a margin of 4 lines may be necessary. Consequently, where the input image Wa is divided into two parts of image D1a and D2a vertically from the boundary portions between DCT blocks in the same way as in the case of FIG. 5, the main processor 11 extracts an assigned image E1 from the input image Wa as shown in FIG. 10. The assigned image E1 includes the upper part of the image D1a and the marginal image M1. The marginal image M1 is made of 4 lines on the lower side of the boundary between the parts of the image D1a and D2a and is necessary for processing for BNR on the DCT blocks present at the boundary between the parts of the image D1a and D2a. Furthermore, the main processor extracts an assigned image E2 made of the lower part of the image D2a and the marginal image M2 made of 4 lines on the upper side of the boundary between the parts of the image D2a and D1a. The 4 lines of the marginal image M2 are necessary in performing processing for BNR on the DCT blocks present at the boundary between the parts of the image D2a and D1a.

That is, where plural sets of processing are performed in this way, the image including the marginal image having a larger extent out of the marginal images treated in the sets of processing is extracted as an assigned image. Consequently, a necessary image can be secured in each set of processing.

The main processor 11 supplies the assigned image E1 extracted from the input image Wa, for example, to the coprocessor 14-1, and supplies the assigned image E2 to the coprocessor 14-2.

As shown in FIG. 10, the coprocessor 14-1 performs processing for BNR on the assigned image E1 supplied from the main processor 11, the processing being described by referring to FIGS. 2 and 3. The coprocessor also performs processing for FNR described by referring to FIGS. 6 and 7. The obtained part of the image D1a undergone the processing for BNR and the processing for FNR is supplied to the main processor 11. The part of the image D1a undergone the processing for BNR and the processing for FNR is hereinafter referred to as the part of the image D1e.

As shown in FIG. 10, the coprocessor 14-2 performs processing for BNR on the assigned image E2 supplied from the main processor 11, the processing being described by referring to FIGS. 2 and 4. The coprocessor also performs processing for FNR described by referring to FIGS. 6 and 8. The coprocessor supplies the part of the image D2a undergone the processing for BNR and the processing for FNR to the main processor 11. The part of the image D2a undergone the processing for BNR and the processing for FNR is hereinafter referred to as the part of the image D2e.

The main processor 11 stores the part of the image D1e supplied from the coprocessor 14-1 into an output storage region of the main memory 12 which is in a position corresponding to the position of the part of the image D1a on the input image Wa, and stores the part of the image D2e supplied from the coprocessor 14-2 into an output storage region of the main memory 12 which is in a position corresponding to the position of the part of the image D2a on the input image Wa.

Because the parts of the image D1e and D2e supplied from the coprocessors 14-1 and 14-2 correspond to the parts of the image D1a and D2a, respectively, the input image Wa undergone the processing for BNR and the processing for FNR can be obtained by storing the parts of the image D1e and D2e into the output storage regions in positions corresponding to the positions of the parts of the image D1a and D2a on the input image Wa. The input image Wa undergone the processing for BNR and the processing for FNR is hereinafter referred to as the input image We.

Then, the operations (FIG. 10) of the main processor 11 and coprocessor 14-1 performed where the processing for BNR and processing for FNR are executed are again described by referring to the flowchart of FIG. 11.

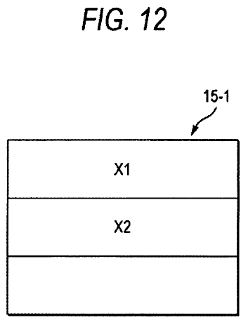

In step S1, the main processor 11 extracts the assigned image E1 from the images Wa to be entered, the images being stored in the main memory 12. The processor reads a constant number of lines (e.g., 16 lines) belonging to the assigned image, transfers the lines to the local memory 15-1, and copies the lines into a storage region X1 shown in FIG. 12. DMA (direct memory access) is used in transferring the data to the local memory 15-1.

In step S2, the coprocessor 14-1 performs processing for BNR on the lines stored in the storage region X1 of the local memory 15-1 in step S1, and stores the obtained image into a storage region X2 of the local memory 15-1.

Then, in step S3, the coprocessor 14-1 performs processing for FNR on the image stored in the storage region X2 in step S2, causes the obtained image to overwrite the image copied in step S1 to the storage region X1 of the local memory 15-1.

In step S4, the coprocessor 14-1 outputs the image written in the storage region X1 of the local memory 15-1 in step S3 to the main memory 12. In step S5, the main processor 11 writes the image output from the coprocessor 14-1 into the output storage region of the main memory 12 in a position corresponding to the position of the image on the input image Wa.

In step S6, the main processor 11 makes a decision with respect to the coprocessor 14-1 as to whether all the data about the assigned image E1 has been copied into the local memory 15-1. If the result of the decision is that there remains any data not yet copied, control returns to step S1, where similar processing is performed about the remaining image.

If the result of the decision made in step S6 is that all the data about the assigned image E1 has been copied, the processing is terminated.

The operation between the main processor 11 and the coprocessor 14-1 has been described so far. The main processor 11 and the coprocessor 14-2 operate fundamentally in the same way.

Since the coprocessor 14 executes the processing utilizing the local memory 15 in this way, the processing for BNR and the processing for FNR can be carried out in a parallel manner to transfer of the results of the processing though in a range of several lines. Consequently, the parallel processing can be effected more efficiently.

In the examples of FIGS. 5, 9, and 10, the input image Wa is divided into two. This is based on the assumption that the two coprocessors 14-1 and 14-2 can execute image processing on the parts of the image D1a and D2a in substantially equal processing times. Where the input image Wa is divided to derive the parts of the image such that the processing times taken by the coprocessors 14 are made substantially equal in this way, the coprocessors 14 perform parallel processing and so the whole processing time can be shortened further.

The aforementioned sequence of operations can be performed in hardware, as well as in software. Where the sequence of operations is carried out in software, a program forming the software is installed in a general-purpose computer.

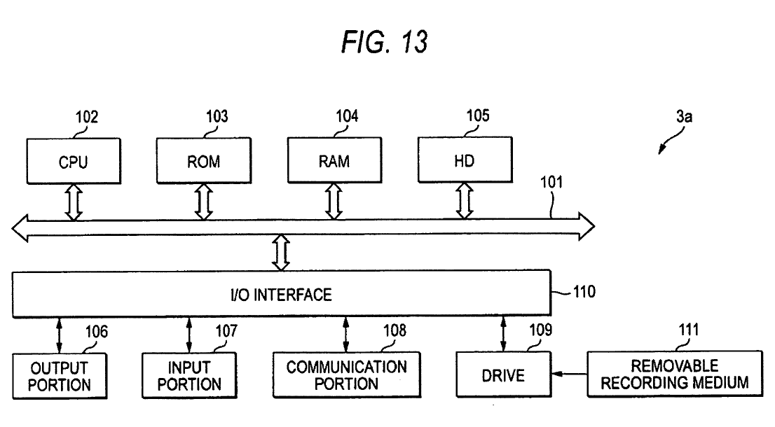

FIG. 13 shows one example of structure of the computer in which a program for executing the above-described sequence of processing operations is installed.

The program can be previously recorded in a hard disk 105 or ROM 103 acting as a recording medium incorporated in a computer.

Alternatively, the program can be temporarily or permanently stored or recorded in a removable recording medium 111 such as a flexible disc, CD-ROM (compact disc read only memory), MO (magnetooptical) disc, DVD (digital versatile disc), magnetic disc, or semiconductor memory. The removable recording medium 111 can be offered in so-called packaged software.

The program can be installed into the computer from the aforementioned removable recording medium 111. Alternatively, the program may be wirelessly transferred from a download site into the computer via an artificial satellite for digital satellite broadcasting. Still alternatively, the program may be transferred with wire to the computer via a network such as a LAN (local area network) or the Internet, and the computer can receive the incoming program by its communication portion 108. The program may then be installed in the internal hard disc 105.

The computer incorporates a CPU (central processing unit) 102. An input/output interface 110 is connected with the CPU 102 via a bus 101. When the user manipulates an input portion 107 including a keyboard, a computer mouse, and a microphone to enter instructions, the instructions are entered into the CPU 102 via the input/output interface 110. Correspondingly, the CPU executes the program stored in the ROM (read only memory) 103. Alternatively, the CPU 102 loads a program into the RAM (random access memory) 104 and executes the program after the program is read from the hard disc 105, or the program may be transferred from a satellite or from a network and received by the communication portion 108 and installed into the hard disc 105. Still alternatively, the program may be read from the removable recording medium 111 mounted in a drive 109 and installed into the hard disc 105. As a result, the CPU 102 performs processing according to the above-described flowchart or performs processing implemented by the configuration shown in the above-described block diagram. As the need arises, the CPU 102 outputs the results of the processing from the output portion 106 including a liquid crystal display (LCD) or loudspeakers, for example, via the input/output interface 110. Alternatively, the results are transmitted from the communication portion 108 or recorded in the hard disc 105.

The processing steps setting forth a program for causing the computer to perform various kinds of processing is not always required to be carried out in a time sequential order set forth in the flowchart in the present specification. The processing steps may be carried out in a parallel manner or separately. For example, they may include parallel processing or processing using objects.

Furthermore, the program may be processed by a single computer or implemented as distributed processing by means of plural computers. In addition, the program may be transferred to a remote computer and executed.

It is to be understood that the present invention is not limited to the above-described embodiments and that various changes and modifications are possible without departing from the gist of the present invention.

What is claimed is:

1. An image processor comprising:
N execution means (where N is 2 or greater) for executing given image processing; and
a control means for dividing an input image into N parts from a boundary portion between given processing unit blocks to be processed by the N execution means and controlling the execution of the image processing on the resulting N parts of the image performed by the N execution means;
wherein the control means extracts an assigned image from the input image for each one of the N parts of the image and assigns the N extracted assigned images to the N execution means, respectively, each of the assigned images including a first part of the image and a marginal image, the marginal image being a portion of a second part of the image adjacent to the first part of the image, the marginal image being necessary in performing the image processing on a given portion of the first part of the image; and
wherein the N execution means execute the image processing on the images assigned by the control means in a parallel manner.

2. An image processor as set forth in claim 1, wherein the execution means carry out processing for block distortion reduction or processing for frame distortion reduction.

3. An image processor as set forth in claim 1, wherein the execution means carry out plural sets of image processing, and wherein the control means extracts an image including a marginal image having a larger extent as the assigned image out of marginal images treated in each set of image processing.

4. An image processor as set forth in claim 3, wherein the execution means carry out both processing for block distortion reduction and processing for frame distortion reduction.

5. An image processing method comprising the steps of:
executing given image processing by means of N execution steps (where N is two or greater); and
dividing an input image into N parts from a boundary portion between given processing unit blocks and controlling the execution of the image processing on the resulting N parts of the image in the N execution steps;
wherein the controlling step extracts an assigned image from the input image for each one of the N parts of the image and assigns the N extracted assigned images to the N execution steps, respectively, each of the assigned images including a first part of the image and a marginal image, the marginal image being a portion of a second part of the image adjacent to the first part of the image, the marginal image being necessary in performing the image processing on a given portion of the first part of the image; and
wherein the N execution steps execute the image processing on the images assigned by the controlling step in a parallel manner.

6. A program for causing a computer to perform image processing comprising the steps of:
executing given image processing by means of N execution steps (where N is two or greater); and
dividing an input image into N parts from a boundary portion between given processing unit blocks and controlling the execution of the image processing on the resulting N parts of the image in the N execution steps;
wherein the controlling step extracts an assigned image from the input image for each one of the N parts of the image and assigns the N extracted assigned images to the N execution steps, respectively, each of the assigned images including a first part of the image and a marginal image, the marginal image being a portion of a second part of the image adjacent to the first part of the image, the marginal image being necessary in performing the image processing on a given portion of the first part of the image; and
wherein the N execution steps execute the image processing on the images assigned by the controlling step in a parallel manner.

7. An image processor comprising:
N execution units (where N is 2 or greater) configured to execute given image processing; and
a control unit configured to divide an input image into N parts from a boundary portion between given processing unit blocks to be processed by the N execution units and to control the execution of the image processing on the resulting N parts of the image performed by the N execution units;
wherein the control unit extracts an assigned image from the input image for each one of the N parts of the image and assigns the N extracted assigned images to the N execution units, respectively, each of the assigned images including a first part of the image and a marginal image, the marginal image being a portion of a second part of the image adjacent to the first part of the image, the marginal image being necessary in performing the image processing on a given portion of the first part of the image; and
wherein the N execution units execute the image processing on the images assigned by the control unit in a parallel manner.
